(19) United States
(12) Patent Application Publication
(10) Pub. No.: US 2011/0031757 A1
(43) Pub. Date: Feb. 10, 2011

(54) Vibration damping sheet for wind power generator blades, vibration damping structure of wind power generator blade, wind power generator, and method for damping vibration of wind power generator blade

(75) Inventors: Yoshiaki Mitsuoka, Osaka (JP); Yasuhiko Kawaguchi, Osaka (JP); Katsuhiko Tachibana, Osaka (JP); Takahiro Fujii, Osaka (JP); Takuji Okeyui, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/805,315

(22) Filed: Jul. 26, 2010

Related U.S. Application Data
(60) Provisional application No. 61/272,002, filed on Aug. 6, 2009.

(30) Foreign Application Priority Data
Aug. 5, 2009 (JP) JP2009-182401

(51) Int. Cl. F03D 9/00; B23P 6/00; F04D 29/38

(52) U.S. Cl. 290/55; 29/889.1; 416/229 R

(57) ABSTRACT

A vibration damping sheet for wind power generator blades includes a resin layer and a restricting layer laminated on the resin layer.

### CROSS REFERENCE TO RELATED APPLICATIONS

This application claims the benefit of U.S. Provisional Application No. 61/272,002, filed on Aug. 6, 2009, which claims priority from Japanese Patent Application No. 2009-182401, filed on Aug. 5, 2009, the contents of which are herein incorporated by reference in their entirety.

### BACKGROUND OF THE INVENTION

1. Field of the Invention

The present invention relates to a vibration damping sheet for wind power generator blades, a vibration damping structure of a wind power generator blade including the sheet, a wind power generator including the structure, and a method for damping vibration of the wind power generator blade.

2. Description of Related Art

In recent years, wind power generators have been received much attention from the viewpoint of CO₂ reduction associated with global warming prevention. The wind power generator usually includes a support and a blade (vane) rotatably supported on the support, the blade rotating in response to wind forces, so that the rotational force thereof can generate electric power.

In the wind power generator, the rigidity capable of bearing wind forces is required for the blade. On the other hand, when an improved power generation efficiency is desired, it is necessary to upsize the blade in order to be efficiently exposed to wind forces.

Such upsized blade is largely exposed to wind forces, resulting in an increase in vibration noise. Therefore, the noise spreads in the neighborhood, and wobbling occurs in the blade, which in turn durability deteriorates.

As a result, the blade is required to have high rigidity and excellent vibration damping properties.

From the above viewpoints, there has been proposed, for example, a windmill blade which is composed of a skin material consisting of carbon fiber reinforced plastic, and a core material consisting of a low density foamed material enclosed by the skin material (cf. Japanese Unexamined Patent Publication No. 2006-274990).

In the windmill blade disclosed in Japanese Unexamined Patent Publication No. 2006-274990, the skin material is formed in a hollow structure having a specific size, and the core material is arranged in the entire hollow space of the skin material, so that both rigidity and vibration damping properties are satisfied.

### SUMMARY OF THE INVENTION

In Japanese Unexamined Patent Publication No. 2006-274990, vibration damping properties is uniformly imparted to the entire windmill blade. However, in this windmill blade, vibration may be partially produced, and if produced, such partial vibration cannot be suppressed sufficiently.

It is an object of the present invention to provide a vibration damping sheet for wind power generator blades, capable of easily and sufficiently damping vibration at any point in a wind power generator blade and also capable of securing light weight, a vibration damping structure of a wind power generator blade, a wind power generator, and a method for damping vibration of the wind power generator blade.

The vibration damping sheet for wind power generator blades of the present invention includes a resin layer and a restricting layer laminated on the resin layer.

In the vibration damping sheet for wind power generator blades of the present invention, it is preferable that the resin layer is made of a rubber composition containing rubber.

In the vibration damping sheet for wind power generator blades of the present invention, it is preferable that the restricting layer is a glass cloth and/or a metal sheet.

In the vibration damping structure of the wind power generator blade of the present invention, the above-mentioned vibration damping sheet for wind power generator blades is adhesively bonded to an inner side surface of a wind power generator blade having a hollow structure.

The wind power generator of the present invention has the above-mentioned vibration damping structure of the wind power generator blade.

The method for damping vibration of the wind power generator blade of the present invention includes the steps of: preparing a vibration damping sheet for wind power generator blades comprising a resin layer and a restricting layer laminated on the resin layer; and adhesively bonding the vibration damping sheet for wind power generator blades to an inner side surface of a wind power generator blade having a hollow structure.

The method for damping vibration of the wind power generator blade of the present invention includes the steps of adhesively bonding the above-mentioned vibration damping sheet for wind power generator blades to an inner side surface of a wind power generator blade having a hollow structure; and heating the vibration damping sheet for wind power generator blades.

The method for damping vibration of the wind power generator blade of the present invention includes the steps of preliminarily heating the above-mentioned vibration damping sheet for wind power generator blades; and adhesively bonding the heated vibration damping sheet for wind power generator blades to an inner side surface of a wind power generator blade having a hollow structure.

According to the vibration damping sheet for wind power generator blades, the vibration damping structure of the wind power generator blade, the wind power generator, and the method for damping vibration of the wind power generator blade of the present invention, the vibration damping sheet for wind power generator blades is arranged in any point in the wind power generator blade to dampen vibration easily and sufficiently, so that excellent vibration damping properties is easily and sufficiently imparted to the wind power generator blade and the light weight of the wind power generator blade can be secured.

### BRIEF DESCRIPTION OF THE DRAWINGS

FIG. 1 is a sectional view showing one embodiment of a vibration damping sheet for wind power generator blades according to the present invention;

FIG. 2 is a front view showing one embodiment of a wind power generator according to the present invention;

FIG. 3 is a sectional view showing one embodiment of a vibration damping structure of and a vibration damping method for a wind power generator blade according to the present invention, which taken along the line A-A of FIG. 2,

(a) showing the step of adhesively bonding a vibration damping sheet for wind power generator blades to a wind power generator blade, and

(b) showing the step of heating the vibration damping sheet for wind power generator blades to cure/thermally adhere a resin layer;

FIG. 4 is a sectional view of another embodiment (embodiment in which a vibration damping sheet for wind power generator blades is adhesively bonded to both ends in a rotation direction of a wind power generator blade) of the vibration damping structure of and the vibration damping method for the wind power generator blade according to the present invention;

FIG. 5 is a sectional view of another embodiment (embodiment in which a vibration damping sheet for wind power generator blades is adhesively bonded to a connecting portion between a skin and a girder of a wind power generator blade) of the vibration damping structure of and the vibration damping method for the wind power generator blade according to the present invention; and

FIG. 6 is a sectional view of another embodiment (embodiment in which a vibration damping sheet for wind power generator blades is adhesively bonded to both radial ends of a wind power generator blade) of the vibration damping structure of and the vibration damping method for the wind power generator blade according to the present invention.

### DETAILED DESCRIPTION OF PREFERRED EMBODIMENTS

The vibration damping sheet for wind power generator blades of the present invention includes a resin layer and a restricting layer laminated on the resin layer.

The resin layer is formed by molding a resin composition in a sheet form.

The resin composition is not particularly limited as long as it contains at least a resin component, and optionally contains a curing agent and a crosslinking agent depending upon the kind of resin component.

The resin component is not particularly limited, and examples thereof include thermosetting composition and thermoplastic composition.

Examples of the thermosetting composition include epoxy-containing composition and acryl-containing composition.

The epoxy-containing composition essentially contains, for example, butyl rubber, acrylonitrile-butadiene rubber, and epoxy resin.

Butyl rubber is a synthetic rubber obtained by copolymerization of isobutene (isobutylene) and isoprene.

Known butyl rubbers can be used as the butyl rubber. The degree of unsaturation thereof ranges, for example, from 0.8 to 2.2, or preferably from 1.0 to 2.0, and the Mooney viscosity (ML₁₊₈, at 125° C.) thereof ranges, for example, from 25 to 90, preferably from 30 to 60, or more preferably from 30 to 55. Such butyl rubber has an excellent vibration damping properties.

The butyl rubber can be used alone or in combination of two or more kinds having different physical properties. The amount of the butyl rubber is in the range of, for example, 30 to 300 parts by weight, or preferably 50 to 250 parts by weight, per 100 parts by weight of the epoxy resin. When the amount of the butyl rubber is less than the above range, the resin layer after heat curing may develop sufficient reinforcement, but may fail to develop its vibration damping properties sufficiently, which may cause difficulties in satisfying both the reinforcement and the vibration damping properties. On the other hand, when the amount of the butyl rubber exceeds the above range, the resin layer may fail to develop reinforcement sufficiently, which in turn may cause difficulties in satisfying both the reinforcement and the vibration damping properties.

The acrylonitrile-butadiene rubber is a synthetic rubber obtained by copolymerization of acrylonitrile and butadiene. As the acrylonitrile-butadiene rubber, for example, a ternary copolymer in which a carboxyl group or the like is introduced is contained.

Known acrylonitrile-butadiene rubber can be used as the acrylonitrile-butadiene rubber. The acrylonitrile-butadiene rubber contains acrylonitrile in the range of, for example, 15 to 50% by weight, or preferably 25 to 40% by weight, and the Mooney viscosity (ML₁₊₄, at 100° C.) thereof ranges, for example, from 25 to 80, or preferably from 30 to 60.

The acrylonitrile-butadiene rubber can be used alone or in combination of two or more kinds having different physical properties. The amount of the acrylonitrile-butadiene rubber is in the range of, for example, 30 to 300 parts by weight, or preferably 50 to 200 parts by weight, per 100 parts by weight of the epoxy resin.

Examples of the epoxy resins include bisphenol A type epoxy resin, bisphenol F type epoxy resin, phenol novolak epoxy resin, cresol novolak epoxy resin, alicyclic epoxy resin, ring containing nitrogen epoxy resin such as triglycidyl isocyanurate, hydantoin epoxy resin, hydrogenated bisphenol A type epoxy resin, aliphatic epoxy resin, glycidyl ether epoxy resin, bisphenol S type epoxy resin, biphenyl epoxy resin, dicyclo epoxy resin, and naphthalene epoxy resin.

The amount of the epoxy resin is, for example, 10 parts by weight or more, or preferably 20 parts by weight or more, per 100 parts by weight of the resin component.

The acryl-containing composition is obtained by polymerization of a monomer component which predominantly contains alkyl(meth)acrylate.

Examples of the alkyl(meth)acrylates include alkyl(meth)acrylate (with a linear or branched alkyl moiety having 1 to 20 carbon atoms) such as butyl(meth)acrylate, hexyl(meth)acrylate, 2-ethylhexyl(meth)acrylate, and nonyl(meth)acrylate. These (meth)acrylates can be used alone or in combination of two or more kinds.

The monomer components can optionally contain a polar group-containing vinyl monomer or a polyfunctional vinyl monomer as well as essentially containing the above-mentioned alkyl(meth)acrylate.

Examples of the polar group-containing vinyl monomer include carboxyl group-containing vinyl monomers or anhydride thereof (such as maleic anhydride); and hydroxyl group-containing vinyl monomers such as hydroxyethyl(meth)acrylate.

Examples of the polyfunctional vinyl monomer include (mono or poly)ethylene glycol di(meth)acrylates such as ethylene glycol di(meth)acrylate; and (meth)acrylate monomer of a polyhydric alcohol such as 1,6-hexandiol di(meth)acrylate.

As for the amount of the monomer components, for example, in the monomer components, the amount of the polar group-containing vinyl monomer is, for example, 30% by weight or less, the amount of the polyfunctional vinyl monomer is, for example, 2% by weight or less, and the amount of the alkyl(meth)acrylate is the remainder thereof.

Examples of the thermoplastic composition include rubber compositions essentially containing rubber, from the viewpoint of heat-sealing (thermally adhering) the resin layer in a low temperature range (e.g., 30 to 120° C.).

The rubber can include the above-mentioned butyl rubber and acrylonitrile-butadiene rubber, and specific examples thereof include styrene-butadiene rubber (e.g., styrene-butadiene random copolymer, styrene-butadiene-styrene block copolymer, styrene-ethylene-butadiene copolymer, and styrene-ethylene-butadiene-styrene block copolymer), styrene-isoprene rubber (e.g., styrene-isoprene-styrene block copolymer), styrene isoprene butadiene rubber, polybutadiene rubber (e.g., 1,4-polybutadiene rubber, syndiotactic-1,2-polybutadiene rubber, and acrylonitrile-butadiene rubber), polyisobutylene rubber, polyisoprene rubber, polychloroprene rubber, isobutylene-isoprene rubber, nitrile rubber, butyl rubber, nitrile butyl rubber, acrylic rubber, reclaimed rubber, and natural rubber. These rubbers may be used alone or in combination. Of these rubbers, butyl rubber and styrene-butadiene rubber are preferable from the viewpoints of adhesion, heat resistance, and vibration damping properties.

The amount of the rubber is, for example, 10 parts by weight or more, or preferably 20 parts by weight or more, per 100 parts by weight of the resin component.

When the resin layer is cured, a thermosetting composition is selected as the resin component and, for example, an epoxy-containing composition is selected as an essential component. The epoxy-containing composition is preferably used alone.

When the resin layer is heat sealed (thermally adhered), a thermoplastic resin is selected as the resin component and, for example, a rubber composition is selected as an essential component. The rubber composition is preferably used alone. In this case, the resin composition is provided as a thermal adhesion type adhesive composition.

The curing agent is an epoxy resin curing agent blended, for example, when the resin component contains the thermosetting composition containing an epoxy resin (epoxy-containing composition).

Examples of the curing agent include amine compounds, acid anhydride compounds, amide compounds, hydrazide compounds, imidazole compounds, and imidazoline compounds. In addition to these, phenol compounds, urea compounds, and polysulfide compounds can be cited as the curing agent.

Examples of the amine compounds include ethylenediamine, propylenediamine, diethylenetriamine, triethylenetetramine, amine adducts thereof, metaphenylenediamine, diaminodiphenylmethane, and diaminodiphenylsulfone.

Examples of the acid anhydride compounds include phthalic anhydride, maleic anhydride, tetrahydrophthalic anhydride, hexahydrophthalic anhydride, methyl nadic anhydride, pyromelletic anhydride, dodecenylsuccinic anhydride, dichlorosuccinic anhydride, benzophenonetetracarboxylic anhydride, and chlorendic anhydride.

Examples of the amide compounds include dicyandiamide and polyamide.

Examples of the hydrazide compounds include dihydrazide such as adipic dihydrazide.

Examples of the imidazole compounds include methylimidazole, 2-ethyl-4-methylimidazole, ethylimidazole, isopropylimidazole, 2,4-dimethylimidazole, phenylimidazole, undecylimidazole, heptadecyl imidazole, and 2-phenyl-4-methylimidazole.

Examples of the imidazoline compounds include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline.

These curing agents may be used alone or in combination.

Of the above-mentioned curing agents, latent curing agents are preferable, and examples of such latent curing agents include dicyandiamide and adipic dihydrazide. Of these curing agents, dicyandiamide is preferably used in terms of adhesion.

The amount of the curing agent is in the range of, for example, 0.5 to 30 parts by weight, or preferably 1 to 10 parts by weight, per 100 parts by weight of the epoxy resin.

If desired, a curing accelerator can be used in combination with the curing agent. Examples of the curing accelerator include tertiary amines such as 1,8-diaza-bicyclo(5,4,0)undecen-7, triethylenediamine, and tri-2,4,6-dimethylaminomethyl phenol; phosphorus compounds such as triphenyl phosphine, tetraphenyl phosphonium tetraphenylborate, and tetra-n-butylphosphonium-o,o-diethyl phosphorodithioate; quaternary ammonium salts; and organic metal salts. These may be used alone or in combination.

The amount of the curing accelerator is in the range of, for example, 0.1 to 20 parts by weight, or preferably 2 to 15 parts by weight, per 100 parts by weight of the epoxy resin, depending upon the equivalent ratio of the curing agent to the epoxy resin.

The crosslinking agent is blended, for example, when the resin component contains a crosslinking resin such as butyl rubber or acrylonitrile-butadiene rubber.

Examples of the crosslinking agent include sulfur, sulfur compounds, selenium, magnesium oxide, lead monoxide, organic peroxides (e.g. dicumyl peroxide, 1,1-ditert-butyl-peroxy-3,3,5-trimethylcyclohexane, 2,5-dimethyl-2,5-ditert-butyl-peroxyhexane, 2,5-dimethyl-2,5-ditert-butyl-peroxyhexyne, 1,3-bis(tert-butyl-peroxyisopropyl)benzene, tert-butyl-peroxyketone, and tert-butyl-peroxybenzoate), polyamines, oximes (e.g., p-quinone dioxime and p,p′-dibenzoyl quinone dioxime, etc.), nitroso compounds (e.g., p-dinitroso benzine, etc.), resins (e.g., alkyl phenol-formaldehyde resin, melamine-formaldehyde condensate, etc.), and ammonium salts (e.g., ammonium benzoate, etc.).

These crosslinking agents may be used alone or in combination. Of these crosslinking agents, sulfur is preferably used in terms of the curing properties and the vibration damping properties.

The amount of the crosslinking agent is, for example, 1 to 20 parts by weight, or preferably 2 to 15 parts by weight, per 100 parts by weight of the resin components. The amount of the crosslinking agent of less than this may induce degradation in vibration damping properties. On the other hand, the amount of the crosslinking agent of more than this may induce reduction in adhesion, which may cause the disadvantage of cost.

If desired, a crosslinking accelerator can be used in combination with the crosslinking agent. Examples of the crosslinking accelerator include zinc oxide, disulfides, dithiocarbamic acids, thiazoles, guanidines, sulfenamides, thiurams, xanthogenic acids, aldehyde ammonias, aldehyde amines, and thioureas. These crosslinking accelerators may be used alone or in combination. The amount of the crosslinking accelerator is in the range of, for example, 1 to 20 parts by weight, or preferably 3 to 15 parts by weight, per 100 parts by weight of the resin component.

In addition to these components described above, a softening agent, a filler, a tackifier, a foaming agent, a foaming auxiliary agent, lubricant, and an antiaging agent may be contained in the resin composition. Further, if desired, known additives such as a thixotropic agent (e.g., montmorillonite etc.), fats and oils (e.g., animal fat and oil, vegetable fat and oil, mineral oil, etc.), pigment, an antiscorching agent, a stabilizer, a plasticizer, an antioxidant, an ultraviolet absorber, a coloring agent, a mildew proofing agent and a flame retardant can also be appropriately contained in the resin composition.

The softening agent may be blended in order to improve the adhesion and the vibration damping properties, and specific examples thereof include liquid rubbers such as liquid isoprene rubber, liquid butadiene rubber, polybutene, and polyisobutylene; liquid resins such as terpene liquid resin; oils such as aliphatic process oil; esters such as phthalate and phosphate; and chloroparaffin.

Of these softening agents, liquid rubbers and liquid resins are preferable, or polybutene is more preferable.

Known polybutene can be used as the softening agent. the polybutene has a kinematic viscosity at 40° C. of, for example, 10 to 200000 mm²/s, or preferably 1000 to 100000 mm²/s, and a kinematic viscosity at 100° C. of, for example, 2.0 to 4000 mm²/s, or preferably 50 to 2000 mm²/s.

These softening agents can be used alone or in combination. The amount of the softening agent is in the range of, for example, 10 to 150 parts by weight, preferably 30 to 120 parts by weight, or more preferably 50 to 100 parts by weight, per 100 parts by weight of the resin component. When the mixing proportion of a softening agent exceeds a mentioned range, strength may deteriorate too much. When the amount of the softening agent is less than the above range, the resin composition may not be sufficiently softened.

The softening agent is suitably blended both when the resin composition contains the thermosetting composition and when the resin composition contains the thermoplastic composition. The softening agent is preferably blended when the resin composition contains butyl rubber, thereby enabling the butyl rubber to be sufficiently softened.

The filler is blended in order to improve handleability, and specific examples thereof include magnesium oxide, calcium carbonate (e.g., calcium carbonate heavy, calcium carbonate light, Hakuenka® (colloidal calcium carbonate), etc.), talc, mica, clay, mica powder, bentonite (e.g., organic bentonite), silica, alumina, aluminium hydroxide, aluminium silicate, titanium oxide, carbon black (e.g., insulating carbon black, acetylene black, etc.), and aluminium powder.

A hollow inorganic fine particle may also be used as the filler.

The outer shape of the hollow inorganic fine particle is not particularly limited as long as its inner shape is hollow. Examples of the outer shape of the hollow inorganic fine particle include a spherical shape and a shape of a polyhedron (e.g., regular tetrahedron, regular hexahedron (cube), regular octahedron, regular dodecahedron, etc.). Of these, the shape of the hollow inorganic fine particle is preferably a hollow spherical shape, that is, a hollow balloon.

The inorganic material of the hollow inorganic fine particle can contain the same inorganic material as in the above-mentioned filler, and specific examples thereof include glass, shirasu, silica, alumina, and ceramics. Of these, glass is preferable.

More specifically, the hollow inorganic fine particle is preferably a hollow glass balloon.

Commercially available products can be used as hollow inorganic fine particles, and examples thereof include CEL-STAR series (CEL-STAR series, hollow glass balloons, manufactured by Tokai Kogyo Co., Ltd.).

The average maximum length (an average particle size in the spherical case) of the hollow inorganic fine particle is in the range of, for example, 1 to 500 μm, preferably 5 to 200 μm, or more preferably 10 to 100 μm.

The hollow inorganic fine particle has a density (true density) of, for example, 0.1 to 0.8 g/cm³, or preferably 0.12 to 0.5 g/cm³. When the density of the hollow inorganic fine particle is less than the above range, the hollow inorganic fine particles significantly float during blending thereof, which may make it difficult to uniformly disperse the hollow inorganic fine particles. On the other hand, when the density of the hollow inorganic fine particle exceeds the above range, production cost may increase.

These hollow inorganic fine particles can be used alone or in combination of two or more kinds.

The blending of the hollow inorganic fine particles allows improvement in the vibration damping properties and reduction in the weight thereof.

These fillers can be used alone or in combination of two or more kinds.

The filler is preferably calcium carbonate, talc, or carbon black. In particular, the containing of the hollow inorganic fine particle as the filler allows reduction in the weight of the resin layer without using any foaming agent.

The amount of the filler is in the range of, for example, 300 parts by weight or less per 100 parts by weight of the resin component, and from the viewpoint of lightweight, the amount of the filler is preferably 20 to 250 parts by weight, or more preferably 100 to 200 parts by weight.

When the hollow inorganic fine particle is also contained as the filler, the content ratio of the hollow inorganic fine particle is in the range of, for example, 5 to 50% by volume, preferably 10 to 50% by volume, or more preferably 15 to 40% by volume, relative to the volume of the resin layer.

When the amount of the hollow inorganic fine particle is less than the above range, the effect of adding the hollow inorganic fine particle may deteriorate. On the other hand, when the amount thereof exceeds the above range, the adhesive strength of the viscoelastic layer may decrease.

The hollow inorganic fine particle is suitably blended when the resin composition contains an acrylic-containing composition.

The tackifier may be blended in order to improve the adhesion and the vibration damping properties, and specific examples thereof include rosin resin (e.g., rosin ester, etc.), terpene resin (e.g., polyterpene resin, terpene-aromatic liquid resin, etc.), cumarone-indene resin (e.g., cumarone resin, etc.), phenolic resin (e.g., terpene-modified phenolic resin etc.), phenol-formalin resin, xylene-formalin resin, and petroleum resin (e.g., alicyclic petroleum resin, aliphatic/aromatic copolymerized petroleum resin, aromatic and petroleum resin, or C5/C6 petroleum resin, C5 petroleum resin, C9 petroleum resin, C5/C9 petroleum resin, etc.).

The tackifier has a softening point of, for example, 50 to 150° C., or preferably 50 to 130° C.

These tackifiers can be used alone or in combination of two or more kinds.

The amount of the tackifier is in the range of, for example, 1 to 200 parts by weight, or preferably 20 to 150 parts by weight, per 100 parts by weight of the resin component.

When the amount of the tackifier is less than the above range, neither the adhesion nor the vibration damping properties may sufficiently be improved. On the other hand, when the amount thereof exceeds the above range, the resin layer may become brittle.

The tackifier is suitably blended both of when the resin composition contains the thermosetting composition and when it contains the thermoplastic composition.

If desired, the foaming agent is blended when the resin layer is desired to be foamed. The foaming agents that may be used include, for example, an inorganic foaming agent and an organic foaming agent. Examples of the inorganic foaming agent include ammonium carbonate, ammonium hydrogen carbonate, sodium hydrogen carbonate, ammonium nitrite, sodium borohydride and azides.

Examples of the organic foaming agent include an N-nitroso compound (N,N′-dinitrosopentamethylenetetramine, N,N′-dimethyl-N,N′-dinitrosoterephthalamide, etc.), an azoic compound (e.g., azobis(isobutyronitrile), azodicarboxylic amide, barium azodicarboxylate, etc.), alkane fluoride (e.g., trichloromonofluoromethane, dichloromonofluoromethane, etc.), a hydrazine compound (e.g., paratoluene sulfonyl hydrazide, diphenylsulfone-3,3′-disulfonyl hydrazide, 4,4′-oxybis(benzene sulfonyl hydrazide), allylbis(sulfonyl hydrazide), etc.), a semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

The foaming agents may be in the form of thermally expansible microparticles comprising microcapsules (gas-filled microcapsule foaming agent) formed by encapsulating thermally expansive material (e.g., isobutane, pentane, etc.) in a microcapsule (e.g., microcapsule of thermoplastic resin such as vinylidene chloride, acrylonitrile, acrylic ester, and methacrylic ester). Commercially available products such as Microsphere (product name; manufactured by Matsumoto Yushi-Seiyaku Co., Ltd.), may be used as the thermally expansible microparticles.

These foaming agents may be used alone or in combination. Of these foaming agents, 4,4′-oxybis(benzene sulfonyl hydrazide) (OBSH) is preferably used in terms of less susceptible to external factors and foaming stability.

The amount of the foaming agent is in the range of, for example, 0.1 to 30 parts by weight, or preferably 0.5 to 20 parts by weight, per 100 parts by weight of the resin component.

The foaming agent is suitably blended when the resin composition contains the thermosetting composition.

If desired, a foaming auxiliary agent can be used in combination with the foaming agent, and specific examples thereof include zinc stearate, a urea compound, a salicylic compound, and a benzoic compound. These foam auxiliary agents may be used alone or in combination. The amount of the foam auxiliary agent is in the range of, for example, 0.1 to 10 parts by weight, or preferably 0.2 to 5 parts by weight, per 100 parts by weight of the resin component.

Examples of the lubricant include stearic acid and metal salts of stearic acid. These lubricants can be used alone or in combination. The amount of the lubricant is in the range of, for example, 0.5 to 3 parts by weight, or preferably 1 to 2 parts by weight, per 100 parts by weight of the resin component.

Examples of the antiaging agent include amine-ketone-type, aromatic secondary amine-type, phenol-type, benzimidazole-type, dithiocarbamate-type, thiourea type, phosphorous-type antiaging agents. These antiaging agents can be used alone or in combination. The amount of the antiaging agent is in the range of, for example, 0.01 to 10 parts by weight, or preferably 0.1 to 5 parts by weight, per 100 parts by weight of the resin component.

When the resin composition contains a thermosetting resin and a curing agent, the resin layer can be a curable resin layer. When the resin composition contains a thermoplastic resin (and does not contain a thermosetting composition, a curing agent, and a crosslinking agent), the resin layer can be a heat sealable (thermally adherable) resin layer.

In order to prepare a resin composition (resin composition not containing an acrylic-containing composition), the above-mentioned components are blended in the above-mentioned amounts, and these blended mixture is uniformly mixed (kneaded). A mixing roll, a pressure kneader, or an extruder is used for kneading of the components, for example.

The kneaded material thus obtained is preferably prepared so as to have a flow tester viscosity (50° C., 20 kg load) of, for example, 5000 to 30000 Pa·s, or further 10000 to 20000 Pa·s.

Thereafter, the kneaded material thus obtained is rolled into a sheet form, for example, by calendaring, extrusion, or press molding to thereby form the resin layer.

In the formation of the resin layer, temperature conditions are set under the temperature condition where a curing agent does not substantially decompose (e.g., at 60 to 100° C.) when the resin layer contains the curing agent.

When the resin composition contains an acrylic-containing composition, a monomer component (a precursor, preferably a precursor containing a hollow inorganic fine particle and a monomer component) is prepared, the resulting component is applied onto a surface of a restricting layer or a release film (to be described later), and the applied component is then polymerized (ultraviolet cured) on the surface thereof.

When the resin composition is made from an acrylic-containing composition, air bubble cells are preferably contained in the resin composition.

In order to contain air bubble cells in the resin composition, for example, air bubbles are mixed in a monomer component (precursor, or preferably a syrup in which the precursor is partially polymerized) and the monomer component (unpolymerized monomer component) is then polymerized.

The content ratio of the air bubble cell is in the range of, for example, 5 to 50% by volume, preferably 8 to 30% by volume, or more preferably 10 to 20% by volume.

The containing of the air bubble cells in the resin composition allows further improvement in the vibration damping properties and reduction in the weight of the resin layer.

The resin layer thus formed has a thickness of, for example, 0.5 to 5.0 mm, or preferably 1.0 to 3.0 mm.

The restricting layer serves to restrain the resin layer to maintain the shape of the heated resin layer, and serves to provide tenacity for the resin layer to achieve improved strength. The restricting layer is in the form of a sheet and is formed of light weight and thin-film material to be stuck firmly and integrally with the heated resin layer. The materials that may be used for the restricting layer include, for example, glass fiber cloth, metal sheet, synthetic resin unwoven cloth, carbon cloth, and plastic film. These may be used alone, or may be used by laminating a plurality of layers (materials).

The glass cloth is a cloth formed of glass fibers, and examples thereof include glass unwoven cloth (glass cloth) or glass woven cloth. Of these, a glass cloth is preferable.

A resin-impregnated glass cloth is included as the glass cloth. The resin-impregnated glass cloth is the above mentioned glass cloth impregnated with synthetic resin such as thermosetting resin or thermoplastic resin, and a known resin-impregnated glass cloth can be used. Examples of the thermosetting resin include epoxy resin, urethane resin, melamine resin, and phenol resin. Examples of the thermoplastic resin include vinyl acetate resin, ethylene vinyl acetate copolymer (EVA), vinyl chloride resin, and EVA-vinyl chloride resin copolymer. The thermosetting resin mentioned above and the thermoplastic resin mentioned above (e.g., melamine resin and vinyl acetate resin) may be combined.

Examples of the metal sheet include known metal sheets such as an aluminum sheet, a steel sheet, and a stainless sheet.

Examples of the synthetic resin unwoven cloth include polypropylene resin unwoven cloth, polyethylene resin unwoven cloth, olefin resin unwoven cloth, and ester resin unwoven clothe such as polyethylene terephthalate resin unwoven cloth.

The carbon cloth is a cloth formed of fibers (carbon fibers) which mainly use carbon, and examples thereof include carbon fiber nonwoven cloth and carbon fiber woven cloth.

Examples of the plastic film include polyester films such as polyethylene terephthalate (PET) film, polyethylene naphthalate (PEN) film, and polybutylene terephthalate (PBT) film; and polyolefin films such as polyethylene film and polypropylene film. Of these, PET film is preferable.

Of these materials, the glass cloth and/or the metal sheet is/are preferably used, in terms of lightweight, degree of adhesion, strength, and cost.

The restricting layer has a thickness of, for example, 0.05 to 0.50 mm, or preferably 0.10 to 0.40 mm. The restricting layer, when formed of metal sheet, has a thickness of preferably 200 μm or less, from the viewpoint of handleability. Further, the restricting layer, when formed of glass cloth, has a thickness of preferably 300 μm or less, from the viewpoint of handleability.

The vibration damping sheet for wind power generator blades can be obtained by laminating the restricting layer on the resin layer.

In particular, the process of laminating the resin layer and the restricting layer include, for example, a process (direct formation process) of directly laminating the resin layer on a surface of the restricting layer or a process (transferring process) of laminating the resin layer on a surface of the release film, and subsequently transferring the resin layer onto a surface of the restricting layer.

The vibration damping sheet for wind power generator blades thus obtained has a thickness of, for example, 0.6 to 5.5 mm, or preferably 1.1 to 3.5 mm.

When the thickness of the vibration damping sheet for wind power generator blades exceeds the above range, it may become difficult to attain reduction in the weight of the vibration damping sheet for wind power generator blades, and production cost may increase. When the thickness of the vibration damping sheet for wind power generator blades is less than the above range, the vibration damping properties may not be sufficiently improved.

On the vibration damping sheet for wind power generator blades thus obtained, if desired, a release film (separator) can be adhesively bonded to the surface (the surface opposite to the rear surface where the restricting layer is laminated) of the resin layer until the sheet is actually used.

Examples of the release film include known release films such as synthetic resin films including polyethylene film, polypropylene film, and PET film.

When the vibration damping sheet for wind power generator blades thus obtained is displaced by 1 mm, the flexural strength thereof is, for example, 10 to 30N, or preferably 13 to 25N. When the flexural strength is less than the above range, the vibration of the wind power generator blade may not be damped sufficiently. A method for measuring the flexural strength will be described below.

<Flexural Strength>

First, a 2-mm-thick vibration damping sheet for wind power generator blades (1.8 mm in thickness of a reinforcement layer, and 0.2 mm in thickness of a restricting layer) is cut into a piece having a size of 25×150 mm, and the piece is stuck on a test steel plate (thin plate) having a size of 0.8×10×250 mm.

Then, the stuck steel plate is heated at 180° C. for 20 minutes to obtain a test piece.

The test piece after heating is then supported at a span of 100 mm, with the test steel plate facing upward, and a testing bar is moved down to the lengthwise center of the test piece from above in a vertical direction at a compression rate of 1 mm/min. After the testing bar comes in contact with the test steel plate and the resin layer (a cured layer or a heat-sealing layer, to be described later) after heating is then displaced by 1 mm. At this point, the flexural strength is measured.

The vibration damping sheet for wind power generator blades has a loss factor of, for example, 0.03 to 0.2, or preferably 0.04 to 0.15 at 0° C., 20° C., 40° C., and 60° C. When the loss factor is less than the above range, vibration of the wind power generator blade may not be damped sufficiently. A method for determining the loss factor will be described below.

<Loss Factor (Vibration Damping Properties)>

First, a 2-mm-thick vibration damping sheet for wind power generator blades (1.8 mm in thickness of a reinforcement layer, and 0.2 mm in thickness of a restricting layer) is cut into a piece having a size of 10×250 mm, and the piece is stuck on a test steel plate having a size of 0.8×10×250 mm.

Then, the stuck steel plate is heated at 180° C. for 20 minutes to obtain a test piece.

Thereafter, with the test piece after heating, the loss factor at the secondary resonance point was determined at each temperature of 0° C., 20° C., 40° C., and 60° C. by a central excitation method. An index of excellent vibration damping properties of the loss factor is 0.02 or more, or further 0.04 or more.

The vibration damping sheet for wind power generator blades of the present invention is used in order to dampen vibration of the wind power generator blade of the wind power generator.

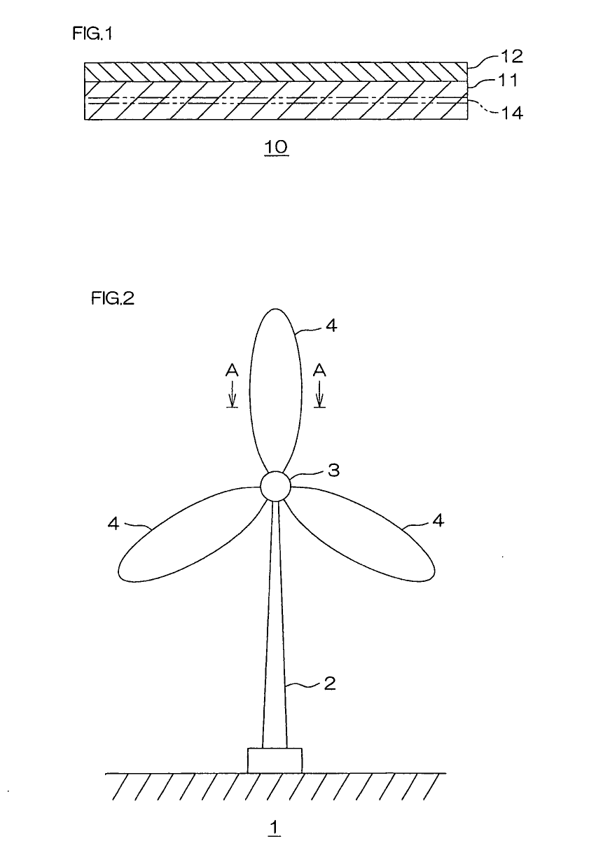

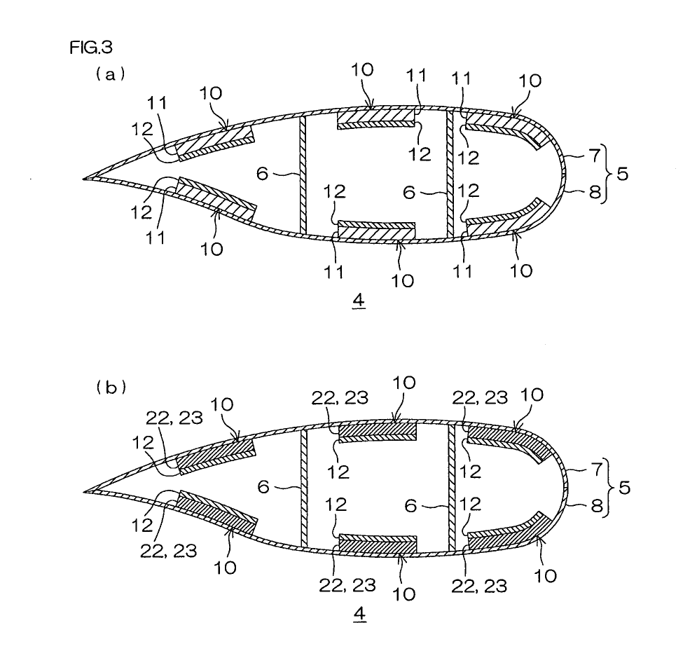

FIG. 1 is a sectional view showing one embodiment of a vibration damping sheet for wind power generator blades according to the present invention, FIG. 2 is a front view showing one embodiment of a wind power generator according to the present invention, and FIG. 3 is a sectional view showing one embodiment of a vibration damping structure of and a vibration damping method for a wind power generator blade according to the present invention, which taken along the line A-A of FIG. 2.

One embodiment of the vibration damping structure of and the vibration damping method for the wind power generator blade according to the present invention will be described below with reference to FIGS. 1 to 3.

In FIG. 2, the wind power generator 1 includes a support 2 vertically arranged in a standing condition, a rotating shaft 3 provided on the upper end portion of the support 2, and a wind power generator blade 4 connected to the rotating shaft 3 and rotatably provided on the support 2.

The wind power generator blade 4 composes a plurality of vanes radially extended from the rotating shaft 3, and has a skin 5 and a girder 6 as shown in FIG. 3(a).

The skin 5 has a generally drop-shaped cross-section and is formed from a half-split structure including a first skin 7 and a second skin 8. The skin 5 is also formed in a hollow structure in the following manner: After a vibration damping sheet 10 for wind power generator blades and the girder 6 are disposed, both ends of the first skin 7 and the second skin 8 are abutted against each other in opposed relation, and these abutted skins are connected to form a hollow space (closed cross section).

The materials that may be used to form the skin 5 include, for example, carbon such as a carbon fiber; synthetic resin such as FRP (fiber reinforced plastics), polypropylene, polyvinyl chloride (PVC), polyester, and epoxy; metal such as aluminium alloy, magnesium alloy, titanium alloy, and ferrous steel; and wood such as balsa. Of these, FRP is preferable.

The girder 6 is arranged in the hollow space of the skin 5, coupled to the inner side surface of the first skin 7 and the inner side surface of the second skin 8, and is formed in the shape of a generally flat plate extending along the radial direction of the wind power generator blade 4. A plurality (two) of the girders 6 are arranged in spaced relation from each other in the rotation direction of the wind power generator blade 4, each arranged over the radial direction of the wind power generator blade 4.

The materials that may be used to form the girder 6 are the same materials as used to form the skin 5 mentioned above.

The vibration damping sheet 10 for wind power generator blades include a resin layer 11 and a restricting layer 12 laminated thereon, as shown in FIG. 1. In order to dampen vibration of the wind power generator blade 4 with the vibration damping sheet 10 for wind power generator blades, as shown in FIG. 3(a), the resin layer 11 is adhesively bonded (temporarily attached or temporarily fixed) to the inner side surface of the first skin 7 and the inner side surface of the second skin 8 of the wind power generator blade 4.

In particular, first, the vibration damping sheet 10 for wind power generator blades are processed (cut) into a generally elongated rectangular shape so as to correspond to the adhesively bonded area to be described below.

Subsequently, the vibration damping sheet 10 for wind power generator blades is adhesively bonded to one end portion, the center portion, and the other end portion in the rotation direction divided by the girder 6 over the radial direction of the wind power generator blade 4.

The resin layer 11 is pressurized with a pressure of, for example, about 0.15 to 10 MPa when adhesively bonded.

Thereafter, the vibration damping sheet 10 for wind power generator blades adhesively bonded to the wind power generator blade 4 is heated.

In particular, when the resin layer 11 is a curable resin layer, it is heated, for example, at 140 to 160° C. Due to such heating, the resin layer 11 is cured. When the resin composition of the resin layer 11 further contains a crosslinking agent, the resin layer 11 is cured and crosslinked simultaneously.

Then, as shown in FIG. 3(b), the resin layer 11 is cured to increase its strength, thereby forming a cured layer 22. Thus, the vibration damping sheet 10 for wind power generator blades can improve the strength of the wind power generator blade 4 to which the vibration damping sheet 10 for wind power generator blades is adhesively bonded.

Besides, the cured layer 22 obtained by curing the resin layer 11 is lightweight and can effectively suppress the increase in weight of the wind power generator blade 4. Further, during (in the course of) curing and after curing, the resin layer 11 under curing (or the cured layer 22 after curing) is restrained by the restricting layer 12, so that the shape of the cured layer 22 is satisfactorily maintained and the restricting layer 12 can provide further improved strength of the vibration damping sheet 10 for the wind power generator blade 4.

Further, when the resin layer 11 is a heat-sealable resin layer which does not cure, it is heated, for example, within the low temperature range described above, specifically, at a temperature of 30 to 120° C.

In particular, the heating temperature is usually a heat resistant temperature of the wind power generator blade 4 or lower, depending upon the type (melting point, softening temperature, etc.) of the thermoplastic composition. When the resin composition contains a rubber composition as the thermoplastic composition, the heating temperature is in the range of, for example, 30 to 120° C., preferably 60 to 110° C., or more preferably 80 to 110° C.

The heating time is, for example, for 0.5 to 60 minutes, or preferably 1 to 10 minutes.

When the heating temperature and the heating time are less than the above ranges, the wind power generator blade 4 and the restricting layer 12 cannot be firmly stuck, or the vibration damping properties during vibration dampening of the wind power generator blade 4 may not sufficiently be improved. When the heating temperature and the heating time exceed the above range, the wind power generator blade 4 may deteriorate or melt.

Then, at the same time of the heating or after the heating, if desired, the vibration damping sheet 10 for wind power generator blades is pressurized to an extent that the resin composition does not flow out of the bonded area, specifically at a pressure of, for example, 0.15 to 10 MPa, using a press.

During the pressurization, at the same time of or after heating of the vibration damping sheet 10 for wind power generator blades and the skin 5, for example, the resin layer 11 is press-contacted toward the side of the skin 5, for example, at a rate of 5 to 500 mm/min and a pressure of 0.05 to 0.5 MPa with a laminator roll, a hand roll (roller) or a spatula.

Then, as shown in FIG. 3(b), the above heating causes the resin layer 11 to be formed into a heat-sealing layer 23, Further, the pressurization causes the heat-sealing layer 23 to be firmly stuck and heat-sealed (adhered) to the skin 5 and the restricting layer 12. Therefore, the heat sealing of the heat-sealing layer 23 can improve the strength of the skin 5.

In addition, since the resin layer 11 does not contain any of a thermosetting resin, a curing agent, and a crosslinking agent, good storage stability of the resin layer 11 can be ensured and the vibration of the skin 5 can be damped by heating and pressurizing the resin layer 11 at low temperature for a short period of time as described above. As a result, the vibration damping sheet 10 for wind power generator blades including the resin layer 11 is reliably produced, and while the use of the vibration damping sheet 10 for wind power generator blades is ensured, the vibration of the skin 5 can be reliably damped by heating and pressurizing the vibration damping sheet 10 for wind power generator blades at low temperature for a short period of time.

The resin layer 11 can further be heated (thermocompression bonded) with the pressurization shown in FIG. 3(a). Specifically, the vibration damping sheet 10 for wind power generator blades is preliminarily heated, and the heated vibration damping sheet 10 for wind power generator blades is subsequently adhesively bonded to the wind power generator blade 4.

The thermocompression bonding conditions are as follows: The heating temperature is, for example, 80° C. or higher, preferably 90° C. or higher, or more preferably 100° C. or higher, and usually a heat resistant temperature of the wind power generator blade 4 or lower, specifically, 130° C. or lower, preferably 30 to 120° C., or more preferably 80 to 110° C.

After the heating and the pressurization (see FIG. 3(a)) described above, further heating can be performed as shown in FIG. 3(b).

Then, the above-mentioned vibration damping sheet 10 for wind power generator blades is adhesively bonded to the wind power generator blade 4, and the vibration damping sheet 10 for wind power generator blades is heated. This allows the resin layer 11 (the cured layer 22 or the heat-sealing layer 23) after heating to be firmly stuck to the skin 5 of the wind power generator blade 4, thereby forming a damping structure of the wind power generator blade 4 whose vibration is damped by the vibration of the vibration damping sheet 10 for wind power generator blades.

In the vibration damping structure of and the vibration damping method for the wind power generator blade 4, the vibration damping sheet 10 for wind power generator blades is arranged in any area (or only an area that requires vibration damping) in the wind power generator blade 4, and easily and sufficiently damped, so that the rigidity of the wind power generator blade 4 can be easily and reliably secured, and the light weight of the wind power generator blade 4 can be secured.

When the above-mentioned vibration damping sheet 10 for wind power generator blades is adhesively bonded to the wind power generator blade 4, the vibration damping sheet 10 (resin layer 11) for wind power generator blades was heated. For example, when the resin layer 11 is formed of thermoplastic composition having a rubber composition, however, if desired, the vibration damping sheet 10 (resin layer 11) for wind power generator blades can be adhesively bonded without heating. In such case, the resin layer 11 is press-contacted toward the side of the skin 5 at room temperature (23° C.). In this case, the resin composition is provided as a room-temperature-adhering type adhesive composition.

The vibration damping sheet 10 (resin layer 11) for wind power generator blades is preferably heated. This can further improve the adhesion over the skin 5 of the resin layer 11, which in turn can achieve further improvement in vibration damping properties.

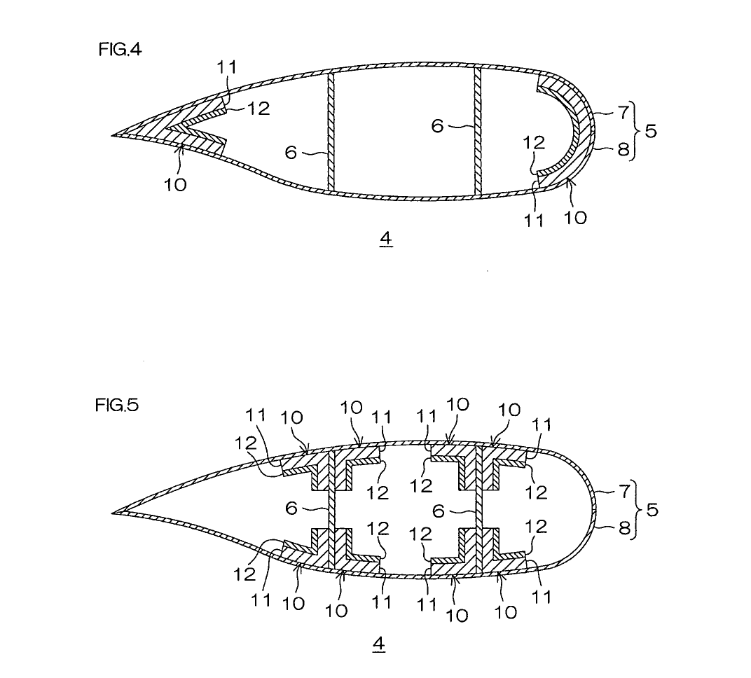

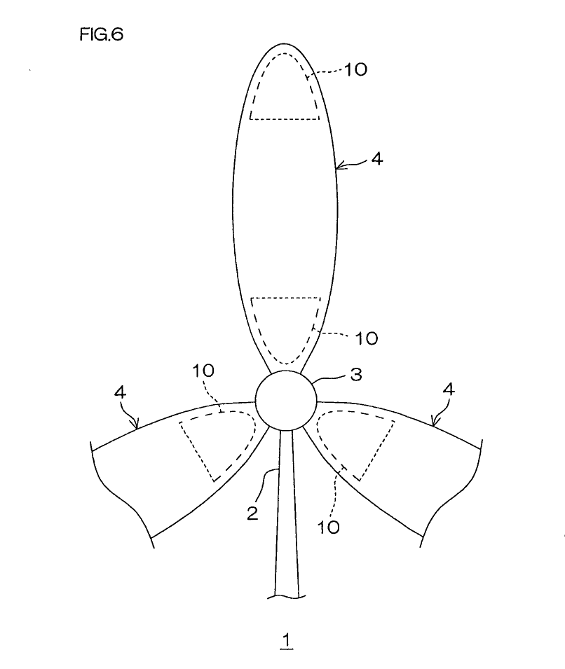

FIGS. 4 to 6 are sectional views of another embodiment of the vibration damping structure of the wind power generator blade according to the present invention. FIG. 4 is an embodiment in which a vibration damping sheet for wind power generator blades is adhesively bonded to both ends in a rotation direction of a wind power generator blade, FIG. 5 is an embodiment in which a vibration damping sheet for wind power generator blades is adhesively bonded to a connecting portion between a skin and a girder of a wind power generator blade, and FIG. 6 is an embodiment in which a vibration damping sheet for wind power generator blades is adhesively bonded to both radial ends of a wind power generator blade.

The same reference numerals are provided in each of the subsequent figures for members corresponding to each of those described above, and their detailed description is omitted.

In the above explanation of FIG. 3(a), the vibration damping sheet 10 for wind power generator blades is adhesively bonded to each of one end portion, a center portion, and the other end portion in the rotation direction of the skin 5. The bonded areas of the vibration damping sheet 10 for wind power generator blades are not limited thereto. For example, the bonded areas can be both ends in the rotation direction of the wind power generator blade 4 as shown in FIG. 4, the connecting portion between the skin 5 and the girder 6 of the wind power generator blade 4 as shown in FIG. 5, and further, both radial ends of the wind power generator blade 4 as shown in FIG. 6.

In FIG. 4, the vibration damping sheet 10 for wind power generator blades is continuously provided on the inner side surface of one end portion of the first skin 7 and that of one end portion of the second skin 8. The vibration damping sheet 10 for wind power generator blades is also adhesively bonded continuously to the inner side surface of the other end of the first skin 7 and that of the other end of the second skin 8.

In FIG. 5, the vibration damping sheet 10 for wind power generator blades is adhesively bonded in a generally L-shaped cross section to one end side surface of the girder 6 and the inner side surface of the first skin 7, and to the other end side surface of the girder 6 and the inner side surface of the second skin 8.

In the above explanation, the vibration damping sheet 10 for wind power generator blades is provided over the entire wind power generator blade 4 in the radial direction. However, for example, as shown in FIG. 6, it can also be provided in a part of the wind power generator blade 4 in the radial direction.

As indicated by dashed lines in FIG. 6, the vibration damping sheet 10 for wind power generator blades is adhesively bonded only to the outer end and the inner end of the wind power generator blade 4 in the radial direction.

In the explanation of the above-mentioned vibration damping sheet 10 for wind power generator blades in FIG. 1, the resin layer 11 is formed only from one sheet made of resin composition. However, for example, as indicated by phantom lines in FIG. 1, a nonwoven cloth 14 may be interposed partway in the thickness direction of the resin layer (preferably, a resin layer made of thermoplastic resin) 11.

The nonwoven cloth 14 includes the same as the synthetic resin nonwoven cloth mentioned above. The nonwoven cloth 14 has a thickness of, for example, 0.01 to 0.3 mm.

The vibration damping sheet 10 for wind power generator blades is produced in the following processes. For example, according to the direct formation process, a first resin layer is laminated on a surface of the restricting layer 12, the nonwoven cloth 14 is laminated on a surface (opposite to the rear surface where the restricting layer 12 is laminated) of the first resin layer, and a second resin layer is subsequently laminated on a surface (opposite to the rear surface where the first resin layer is laminated) of the nonwoven cloth 14.

According to the transferring process, the nonwoven cloth 14 is sandwiched between the first resin layer and the second resin layer from both the front surface side and the rear surface side of the nonwoven cloth 14. Specifically, first, the first resin layer and the second resin layer are formed on the surfaces of two sheets of release film respectively, and the first resin layer is then transferred to the rear surface of the nonwoven cloth 14 while the second resin layer is transferred on the front surface of the nonwoven cloth 14.

The interposing of the nonwoven cloth 14 allows the resin layer 11 to be easily formed with a thick thickness corresponding to the thickness of the wind power generator blade 4 where vibration is desired to be damped.

While the illustrative embodiments of the present invention are provided in the above description, such is for illustrative purpose only and it is not to be construed limitative. Modification and variation of the present invention that will be obvious to those skilled in the art is to be covered by the following claims.

What is claimed is:

1. A vibration damping sheet for wind power generator blades, comprising a resin layer and a restricting layer laminated on the resin layer.

2. The vibration damping sheet for wind power generator blades according to claim 1, wherein the resin layer is made of a rubber composition containing rubber.

3. The vibration damping sheet for wind power generator blades according to claim 1, wherein the restricting layer is a glass cloth and/or a metal sheet.

4. A vibration damping structure of a wind power generator blade, wherein a vibration damping sheet for wind power generator blades comprising a resin layer and a restricting layer laminated on the resin layer is adhesively bonded to an inner side surface of a wind power generator blade having a hollow structure.

5. A wind power generator having a vibration damping structure of a wind power generator blade in which a vibration damping sheet for wind power generator blades comprising a resin layer and a restricting layer laminated on the resin layer is adhesively bonded to an inner side surface of a wind power generator blade having a hollow structure.

6. A method for damping vibration of a wind power generator blade, comprising the steps of: preparing a vibration damping sheet for wind power generator blades comprising a resin layer and a restricting layer laminated on the resin layer; and
adhesively bonding the vibration damping sheet for wind power generator blades to an inner side surface of a wind power generator blade having a hollow structure.

7. A method for damping vibration of a wind power generator blade, comprising the steps of:
adhesively bonding a vibration damping sheet for wind power generator blades comprising a resin layer and a restricting layer laminated on the resin layer, to an inner side surface of a wind power generator blade having a hollow structure; and
heating the vibration damping sheet for wind power generator blades.

8. A method for damping vibration of a wind power generator blade, comprising the steps of:
preliminarily heating a vibration damping sheet for wind power generator blades comprising a resin layer and a restricting layer laminated on the resin layer; and
adhesively bonding the heated vibration damping sheet for wind power generator blades to an inner side surface of a wind power generator blade having a hollow structure.
